(19) United States
(12) Patent Application Publication
(10) Pub. No.: US 2015/0015443 A1
(43) Pub. Date: Jan. 15, 2015

(54) COVER DEVICE AND PORTABLE TERMINAL HAVING THE SAME

(71) Applicant: Samsung Electronics Co., Ltd., Gyeonggi-do (KR)

(72) Inventor: Kun-Hak LEE, Gyeonggi-do (KR)

(73) Assignee: Samsung Electronics Co., Ltd.

(21) Appl. No.: 14/330,779

(22) Filed: Jul. 14, 2014

(30) Foreign Application Priority Data
Jul. 12, 2013 (KR) 10-2013-0082273

(51) Int. Cl. H01Q 1/24

(52) U.S. Cl. CPC H01Q 1/243
USPC 343/702

(57) ABSTRACT

A cover device and a portable terminal having the cover device are provided. The cover device includes a rear cover provided with a first antenna, and a front cover rotatably connected to the rear cover and provided with a second antenna communicating with the first antenna, in face to face relation, and an output unit outputting data through communication between the first and second antennas. The portable terminal includes a body, a cover unit detachably installed to the body and including an auxiliary output unit, and an antenna unit configured to output content of the body to the auxiliary output unit by pairing the body with the cover unit.

### PRIORITY

This application claims priority under 35 U.S.C. §119(a) to Korean Patent Application Serial No. 10-2013-0082273 filed on Jul. 12, 2013 in the Korean Intellectual Property Office, the entire disclosure of which is incorporated herein by reference.

### BACKGROUND

1. Field of the Invention

The present disclosure relates to a cover device and a portable terminal having the same.

2. Description of the Related Art

Various electronic devices have been commercialized for users over the past few years. Recently, portable devices such as MP3 players, Portable Multimedia Players (PMP), e-book readers, and smartphones (hereinafter, “portable terminals”), which provide various content items have become increasingly popular. Such portable terminals are equipped with a variety of functions including photo-taking, music, videos, multimedia, games, as well as wireless transmission and reception. A touch screen is typically provided on the front surface of such portable terminals to allow a user to use multiple functions. Recent smartphones have touch screens on the entire front surfaces.

While a portable terminal is being carried or used, the exterior case of the portable terminal or its touch screen is exposed and is vulnerable to scratches or impact-related damage. To prevent such damage, various cases or covers (hereinafter, “cover devices”) are provided to portable terminals. Previously, a cover device that covers a portable terminal is configured so as to cover only the edges of the portable terminal or only the rear case of the portable terminal, while exposing the touch screen. Alternatively, the cover device is configured to cover the entirety of the portable terminal with a flip case, and to open or cover the touch screen of the portable terminal.

If a cover device is configured to expose the touch screen of a portable terminal, it is difficult to protect the touch screen against scratches or damage. Moreover, in the case of the flip-type cover device that covers the touch screen, each time a user uses the touch screen, the user must open or close the cover, covering the touch screen inconveniently. Even for simple transmission and reception, the user is often required to open the cover. Since whenever the user uses the portable terminal, particularly the touch screen, the user should open the flip-type cover device, frequent opening or closing of the cover may damage the flip cover device. Both a cover device covering only the exterior of a portable terminal and a flip-type cover device are similar in that the touch screen on both is exposed outward for the user to use making the touch screen vulnerable to damage such as scratches.

### SUMMARY

The present invention has been made to address at least the above-mentioned problems and/or disadvantages and to provide at least the advantages described below. Accordingly, an aspect of the present invention is to provide a cover device that can output data on its front surface and does not require an additional power supply for the data output, and a portable terminal having the cover device.

Another aspect of the present invention is to provide a cover device that outputs content displayed on a screen of a portable terminal through its front surface, even when the cover device is folded around the portable terminal, and a portable terminal having the cover device.

Another aspect of the present invention is to provide a cover device that can output various types of predetermined data such as photos, memos, and the like through its front surface so that a user may change a design for the front surface of the cover device according to the user's preferences and may view simple content on the front surface of the cover device, and a portable terminal having the cover device.

In accordance with an aspect of the present invention, a cover device is provided. The cover device includes a rear cover provided with a first antenna, and a front cover rotatably connected to the rear cover and provided with a second antenna communicating with the first antenna, in face to face relation, and an output unit outputting data through communication between the first and second antennas.

In accordance with another aspect of the present invention, a portable terminal having a cover device is provided. The portable terminal includes a body, a cover unit detachably installed to the body and including an auxiliary output unit, and an antenna unit configured to output content of the body to the auxiliary output unit by pairing the body with the cover unit.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIGS. 1A and 1B illustrate a portable terminal having a cover device and the portable terminal from which a front cover is opened, according to an embodiment of the present invention;

FIG. 2 is a block diagram of an Input/Output (I/O) unit in the portable terminal illustrated in FIGS. 1A and 1B;

FIG. 3 illustrates the cover device illustrated in FIGS. 1A and 1B;

FIG. 4 is a sectional view of the cover device illustrated in FIGS. 1A and 1B, taken along line A-A′;

FIG. 5 is a sectional view of the cover device illustrated in FIGS. 1A and 1B, where the front cover of the cover device is rotated outward;

FIG. 6 is a sectional view of the cover device illustrated in FIGS. 1A and 1B, taken along line B-B′;

FIG. 7 is a sectional view of the cover illustrated in FIGS. 1A and 1B, illustrating antennas of an antenna unit nearing each other as the front cover of the cover device is rotated outward;

FIG. 8 is a block diagram illustrating a method for operating the cover device illustrated in FIGS. 1A and 1B;

FIG. 9 is a sectional view of a cover device illustrated in FIGS. 1A and 1B, taken along line A-A′, in which a cover device covers a portable terminal having a rear case in a body, where the front cover of the cover device is rotated outward, according to another embodiment of the present invention; and

FIG. 10 is a sectional view of a cover device illustrated in FIGS. 1A and 1B, taken along line B-B′, in which a cover device covers a portable terminal having a rear case in a body, where the front cover of the cover device is rotated outward, according to another embodiment of the present invention.

Throughout the drawings, like reference numerals will be understood to refer to like parts, components, and structures.

### DETAILED DESCRIPTION OF EMBODIMENTS OF THE PRESENT INVENTION

The present invention will be described more fully hereinafter with reference to the accompanying drawings, in which illustrative embodiments of the invention are shown. This invention may, however, be embodied in many different forms and should not be construed as limited to the embodiments set forth herein. Rather, these embodiments are provided so that the description of this invention will be thorough and complete, and will fully convey the scope of the invention to those skilled in the art. The present invention will be defined by the appended claims.

The same or similar reference symbols are used throughout the drawings to refer to the same or like parts or components. Detailed descriptions of well-known functions and structures incorporated herein may be omitted to avoid obscuring the subject matter of the invention. For the same reasons, some components in the accompanying drawings are emphasized, omitted, or schematically illustrated, and the size of each component may not fully reflect its actual size. Accordingly, the present invention is not limited to the relative sizes and distances illustrated in the accompanying drawings.

Although ordinal numbers such as “first”, “second”, “third”, etc. may be used to describe various elements, components, regions, layers and/or sections, these elements, components, regions, layers and/or sections should not be limited by those terms. These terms are only used to distinguish one element, component, region, layer or section from another. Thus, a first element, component, region, layer or section discussed below could be termed a second element, component, region, layer or section without departing from the teachings of the inventive concept. Descriptions shall be understood as to include any and all combinations of one or more of the associated listed items when the items are described by using the conjunctive term “and/or” or the like.

It is to be understood that the singular forms “a”, “an” and “the”, include plural references unless the context clearly dictates otherwise. It will be further understood that the terms “has”, “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

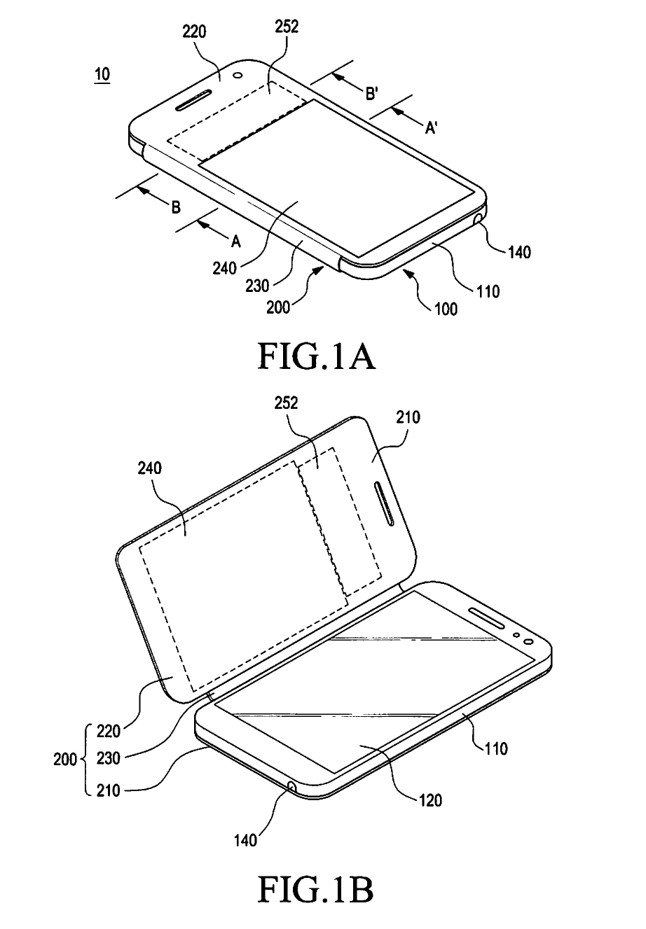

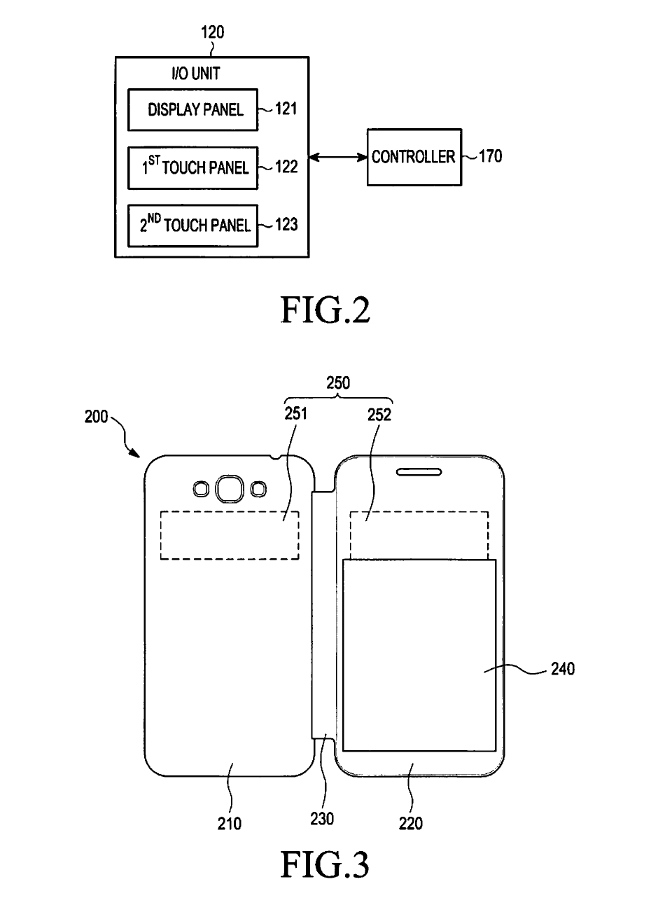

FIG. 1A illustrates a portable terminal having a cover device according to an embodiment of the present invention, FIG. 1B illustrates a portable terminal having a cover device where the front cover of the cover device is opened, and FIG. 2 is a block diagram of an Input/Output (I/O) unit in the portable terminal illustrated in FIGS. 1A and 1B.

Referring to FIGS. 1A, 1B, and 2, a device 10 according to one of various embodiments of the present invention includes a portable terminal 100 and a cover device 200 (hereinafter, “cover unit 200”) covering the portable terminal 100. The device 10 also includes an antenna unit 250 having at least one pair of antennas which are paired and an auxiliary output unit 240.

The portable terminal 100 includes a body 110. The body 110 includes various modules such as a communication module, a multimedia module, a camera module, an audio module, a sensor module, and the like according to the functionalities or structure of the portable terminal 100. In an embodiment of the present invention, the portable terminal 100 includes the body 110 which is a bar type, a large I/O unit 120 on the front surface of the body 110, an input member 140 that applies an input to the I/O unit 120 by contact, and a controller 170 that controls a sensor module or the above components. The portable terminal 100 may further include a camera module installed through the front and rear of the body 110, a button module having a power on/off function, a volume function, a special function, and a connector module that connects the portable terminal 100 to an external device. The portable terminal 100 may also include a transmission module and a reception module.

As described above, the portable terminal 100 includes the I/O unit 120, the input member 140, an internal circuit board, and the controller 170. The I/O unit 120 is a module that is provided on the front surface of the body 110 and displays an output on a screen upon receipt of an input applied by contact or proximity of an object. The I/O unit 120 senses an input from an input member such as a finger or an electronic pen and displays the input. The I/O unit 120 includes a display panel 121 and touch panels 122 and 123.

The display panel 121 may be a Liquid Crystal Display (LCD) panel, an Active Matrix Organic Light Emitting Diode (AMOLED) panel, or the like. The display panel 121 displays various images according to operation states of the portable terminal 100, applications executed in the portable terminal 100, and services provided by the portable terminal 100. In an embodiment of the present invention, one or more touch panels 122 and 123 may be provided. For example, the I/O unit 120 may include a first touch panel 122 that senses contact such as a finger touch in a capacitive manner and a second touch panel 123 that senses contact from a paired input member such as an electronic pen using ElectroMagnetic Resonance (EMR). While the I/O unit 120 is described as having the two touch panels 122 and 123, that is, the I/O unit 120 may include only one touch panel 122 and the display panel 121. While the first touch panel 122 is a capacitive touch panel in the present invention, the first touch panel 121 is not limited to the capacitive configuration. Thus, the first touch panel 122 may be configured into any other type of panel such as a resistive type or an acoustic wave type. A mounting space may be defined in the body 110, particularly in the bottom surface of the body 110, so that the input member 140 may be inserted into or extended from the mounting space.

The cover unit 200 includes a front cover 220, a rear cover 210, a connector 230, an auxiliary output unit 240, and an antenna unit (not shown) consisting of a first antenna (not shown) and a second antenna 252.

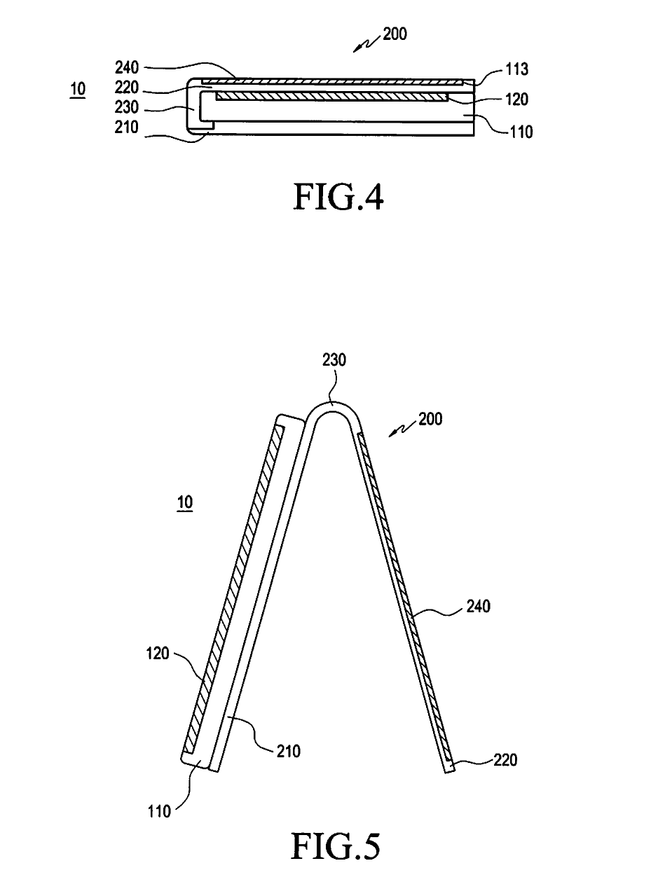

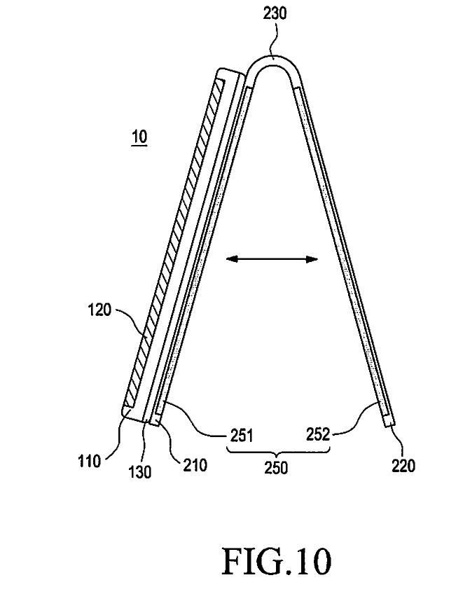

In one embodiment of the present invention, a rear cover 210 of the cover unit 200 is integrally formed with the body 110 to serve as a rear case of the body 110 as illustrated in FIGS. 4 and 5. In another embodiment of the present invention, the body 110 has the rear case 130 on the rear surface of the body 110 and the cover unit 200 covers the body 110 including the rear case 130, as illustrated in FIGS. 9 and 10.

The antenna unit 250 may be installed at different positions in the embodiments of the present invention. Specifically, in a first embodiment of the present invention, one of two antennas included in the antenna unit 250, a first antenna 251 is preferably disposed on the rear cover 210 so that as the rear cover 210 is engaged on the rear surface of the body 110, the first antenna 251 may be connected to the body 110. The other antenna paired with the first antenna 251 in the antenna unit 250, that is, a second antenna 252 is disposed on the cover unit 200, particularly on a front cover 220, as illustrated in FIGS. 1 to 8.

In the second embodiment of the present invention, the first antenna 251 is preferably disposed on the rear case 130 that covers the rear surface of the body 110 so that as the rear case 130 is mounted on the rear surface of the body 110, the first antenna 251 may be connected to the body 110. The second antenna 252 paired with the first antenna 251 in the antenna unit 250 is disposed on the cover unit 200, particularly on the front cover 220, as illustrated in FIGS. 9 and 10. The installation positions of the antenna unit 250 will be described in detail after a description of the configurations of the cover unit 200.FIG. 3 is a detailed diagram illustrating the cover unit 200 in the device 10 illustrated in FIGS. 1A and 1B. Referring to FIG. 3, the portable terminal 100 is provided with the cover unit 200 that protects the portable terminal 100. As previously described, the cover unit 200 includes the front cover 220, the rear cover 210, the connector 230, the auxiliary output unit 240, and the antenna 250 consisting of the first antenna 251 and the second antenna 252. The cover unit 200 is detachably installed to the body 110. In the embodiment of the present invention, the cover unit 200 is a flip cover that may cover both the front and rear surfaces of the body 110 of the portable terminal 100. However, the cover unit 200 of the present invention is not limited to a flip cover. For example, as far as the cover unit 200 can rotate to be folded over the rear surface of the body 110, particularly the rear case 130 illustrated in FIGS. 9 and 10 around a side of the body 100 as a rotation axis, while being folded over the front surface of the body 110, particularly the I/O unit 120, the cover unit 200 may be configured in many other manners.

FIG. 4 is a sectional view of the cover device 200 illustrated in FIGS. 1A and 1B, taken along line A-A′, in state where the front cover 220 is closed. FIG. 5 is a sectional view of the cover device 200 illustrated in FIGS. 1A and 1B in a state where the front cover 220 is rotated outward. FIG. 5 illustrates one embodiment of the present invention, providing a rear cover 210 of the cover unit 200 which is integrally formed with the body 110 to serve as a rear case of the body 110. Referring to FIGS. 4 and 5, the cover unit 200 is a flip cover including the front cover 220, the rear cover 210, a connection member 230, and an auxiliary output unit 240. The front cover 220 is rotatably engaged with the rear cover 210 so as to open or close the I/O unit 120 on the front surface of the body 110. The auxiliary output unit 240 is provided on the front surface of the front cover 220. The inner surface of the front cover 220 is formed of a soft material, such as cloth, to prevent scratches on the display panel 121 of the I/O unit 120 when the front cover 220 contacts the display panel 121.

The connection member 230 connects the front cover 220 to the rear cover 210 in such a manner that the front cover 220 may rotate with respect to the rear cover 210. While the connection member 230 may be formed in a hinge structure, the present invention will be described in the context that the connection member 230 is connected to the front cover 220 using a soft flexible material.

The rear cover 210 is detachably mounted to the rear surface of the body 110 and covers the rear surface of the body 110. As described above, the flip cover of the present invention may be configured in two methods according to the configuration of the rear cover 210. The rear cover 210 is integrated with the body 110 in one configuration, whereas the rear cover 210 is a separate component from the body 110 and is detachably engaged with the body 110 in the other configuration. Integration of the rear cover 210 with the body 110 means that the body 110 is finished as one complete component only when the cover unit 200, particularly the rear cover 210 of the cover unit 200, is provided to the body 110. Thus the cover unit 200 is a component integrated with the body 110 enabling the device 10 to be presented as a single finished product. That is, if the rear cover 210 is not engaged with the body 110, the body 110 is not an integrated component. In the embodiment described herein, the rear cover 210 is integrated with the body 110. Alternatively, if the cover unit 200 is a separate component from the body 110, the cover unit 200 is not integrated with the body 110, and the body 110 is a component in itself apart from the cover unit 200. Accordingly, in such an embodiment, the rear cover 210 is not a part of the body 110 but a separate component from the body 110.

Additionally, a battery mounting space (not shown) is defined into the rear surface of the body 110, to accommodate a battery, and a rear bracket is provided on the rear surface of the body 110. As described before, if the rear cover 210 is integrated with the body 110, the rear cover 210 is mounted to the body 110, covering the rear surface of the body 110. Thus the rear cover 210 serves as an integrated component of the body 110. In this case, the device 10 with the body 110 integrated with the cover unit 200 may be made more slim than when the device 10 has the cover unit 200 as a separate and independent component. Further, the design of device 10 may appear sleeker and more sophisticated when the cover unit 200 is integrated with the body 110. Accordingly, the first antenna 251 is provided on the rear cover 210 in an embodiment of the present invention.

The front cover 220 is connected to the rear cover 210 by the connection member 230. The front cover 220 is rotated with respect to the rear cover 210 integrated with the rear surface of the body 110 to open or close the I/O unit 120 on the front surface of the body 110. The front cover 220 may be configured to rotate 360 degrees around the connection member 230 as an axis so that the front cover 220 may be folded over the front surface or rear surface of the body 110.

The front cover 220 is provided with the second antenna 252 paired with the first antenna 251 and the auxiliary output unit 240. The auxiliary output unit 240 is connected to the second antenna 252. As the second antenna 252 is paired with the first antenna 251, the auxiliary output unit 240 receives data from the second antenna 252 and outputs the data. In the present invention, the auxiliary output unit 240 is formed of electronic paper, for example. By means of electronic ink, electronic paper allows a user to view an image just through an ambient lighting without the need for light from behind a screen as is the case with other displays. Therefore, the electronic paper has the advantage of consuming very low quantities of power. Further, even though pairing does not occur in the antenna unit 250 and thus power is not supplied, content displayed on the electronic paper is kept as it is. Accordingly, there is no need for an additional power supply to maintain a screen or content displayed on the electronic paper, thereby remarkably reducing power consumption.

If the first and second antennas 251 and 252 approach each other and thus are paired as illustrated in FIG. 7, current is instantaneously applied to the electronic paper and thus power is supplied to the electronic paper. Therefore, output of the I/O unit 120 is displayed on the electronic paper of the front cover 220 when the first and second antennas of the antenna unit 250 are paired. If the first and second antennas 251 and 252 recede from each other and thus the antenna pairing does not occur any longer, power is disconnected from the electronic paper. Nonetheless, data displayed on the electronic paper is maintained. Consequently, even when the front cover 220 is folded over the I/O unit 120, the user can view data displayed on the electronic paper.

As described before, the auxiliary output unit 240, provides electronic paper on the front surface of the front cover 220, specifically the surface of the front cover 220 exposed outward when the front cover 220 is folded over the I/O unit 120. To make the surface of the electronic paper even with the front surface of the front cover 220, the electronic paper may be inserted into a recess 113 formed into the front cover 220.

The second antenna 252 is disposed at one side of the auxiliary output unit 240, that is, the electronic paper, while being connected to the electronic paper. The second antenna 252 is provided on the inner surface of the front cover 220, thus limiting inward and outward visual exposure of the second antenna 252. Therefore, the device 10 looks more sophisticated in design.

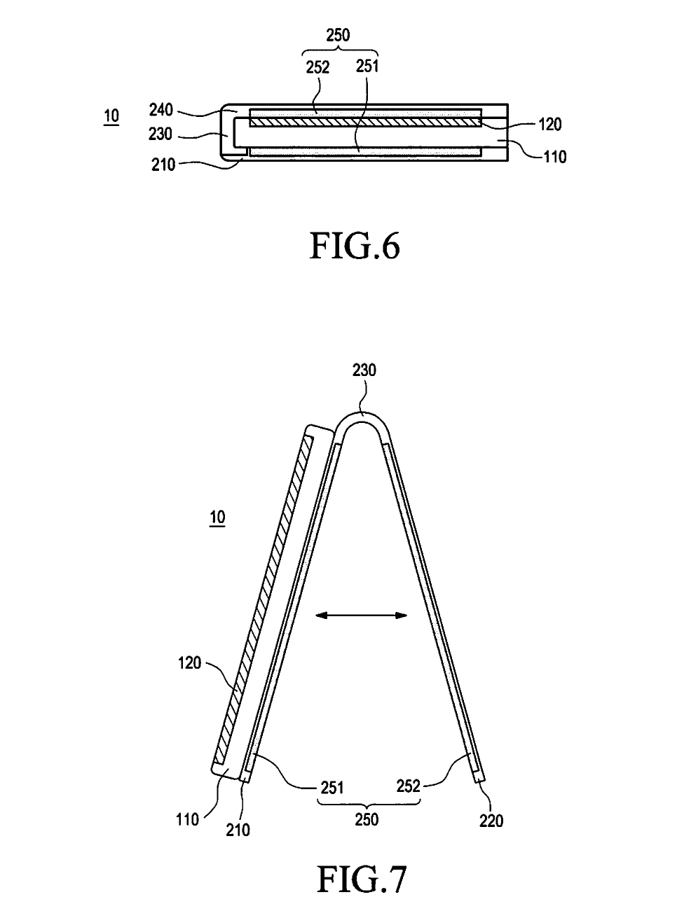

FIG. 6 is a sectional view of the cover unit 200 illustrated in FIGS. 1A and 1B, taken along line B-B′ and FIG. 7 is a sectional view of the cover unit 200 illustrated in FIGS. 1A and 1B, illustrating antennas of an antenna unit 250 nearing each other as the front cover of the cover device is rotated outward. Referring to FIGS. 6 and 7, the antenna unit 250 includes one or more pairs of antennas and pairs the body 110 with the cover unit 200. Specifically, the antenna unit 250 pairs the body 110 with the cover unit 200 so that the body 110 may output data to the auxiliary output unit 240 of the cover unit 200. That is, the body 110 and the auxiliary output unit 240 exchange signals to transfer preset content from the body 110 to the electronic paper. Along with pairing in the antenna unit 250, a screen displayed on the I/O unit 240 may be displayed on the auxiliary output unit 250, particularly the electronic paper. For example, if pairing occurs in the antenna unit 250 while a photo is output to the I/O unit 120, the I/O unit 120 transmits the photo to the auxiliary output unit 240 and thus the photo is displayed on the auxiliary output unit 240. Or at the moment of pairing in the antenna unit 250, a screen to be transmitted to the auxiliary output unit 240 may be displayed on the I/O unit 120. In another example, when pairing occurs in the antenna unit 250, an application that enables data output to the auxiliary output unit 240 or an application that allows selection of data to be output to the auxiliary output unit 240 is executed on the I/O unit 120. Thus, along with pairing in the antenna unit 250, the application displayed on the I/O unit 120 is executed so that user-intended data may be transmitted to the auxiliary output unit 240.

The antenna unit 250 includes a pair of antennas, that is, the first antenna 251 and the second antenna 252 (see FIG. 3). As described before, the first antenna 251 is provided on the rear surface of the body 110, specifically in the rear case 130 illustrated in FIGS. 9 and 10 or in the rear cover 210 of the cover unit 200. If the rear case 130 or the rear cover 210 is integrated with the body 110 on the rear surface of the body 110, the first antenna 251 is connected to internal circuitry (not shown) of the body 110. The second antenna 252 is provided in the cover unit 200, specifically in the front cover 220 of the cover unit 200.

The first and second antennas 251 and 252 are paired without contact, to transmit and receive data to and from each other. That is, when the first and second antennas 251 and 252 are within a short distance, data is paired between the first and second antennas 251 and 252. With the front cover 220 and the rear cover 210 positioned within a specific short distance, the first and second antennas 251 and 252 are preferably positioned on the same line. That is, the first and second antennas 251 and 252 may be installed in the rear cover 210 (or the rear case 130 as is described below) and the front cover 220 at positions where when the first and second antennas 251 and 252 are close to or adjacent to each other, they face each other. Since the second antenna 252 is connected to the auxiliary output unit 240, when the second antenna 252 is paired with the first antenna 251, power is supplied to the electronic paper instantaneously and thus data may be output to the electronic paper.

In an embodiment of the present invention, the first antenna 251 includes a Near Field Communication (NFC) antenna and the second antenna 252 includes a Radio Frequency Identification (RFID) antenna that can be paired with the NFC antenna. However, the first and second antennas 251 and 252 are not limited to the configurations shown herein. As far as the first and second antennas 251 and 252 can be paired within a short distance, any configuration is available to the first and second antennas 251 and 252.

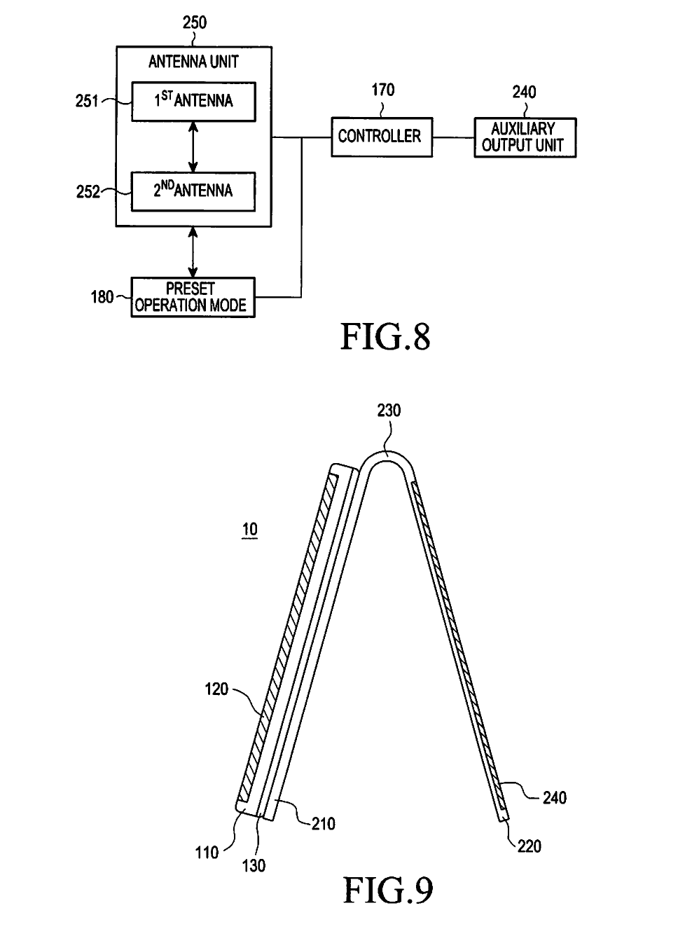

FIG. 8 is a block diagram illustrating an operating state of the device cover illustrated in FIGS. 1A and 1B. Referring to FIG. 8, the body 110 includes the controller 170 that controls pairing of the antenna unit 250 and controls output of data to the auxiliary output unit 240 according to an operation mode. Specifically, if a predetermined operation mode 180 is set in a state where the front cover 220 is close to the rear cover 210, the controller 170 controls pairing in the antenna unit 250, that is, pairing between the first and second antennas 251 and 252. When data is selected and transmitted in the operation mode 180, the controller 170 controls transfer of preset content from the first antenna 251 to the second antenna 252. The controller 170 controls output of the data received at the second antenna 252 to the electronic paper. As described above, if a screen displayed on the I/O unit 120 is set to be output to the auxiliary output unit 240 at the moment of pairing in the antenna unit 250, the controller 170 controls output of the screen from the I/O unit 120 to the auxiliary output unit 240 upon pairing in the antenna unit 250. If a screen used to realize an output to the auxiliary output unit 240 is set to be displayed on the I/O unit 120 at the moment of pairing in the antenna unit 250, the controller 170 controls output of the screen from the I/O unit 120 to the auxiliary output unit 240 upon pairing in the antenna unit 250. As described before, the first antenna 251 is positioned on the rear surface of the body 110 and the second antenna 252 is provided to the front cover 220. While the front cover 220 is folded over the front surface of the body 110, the first and second antennas 251 and 252 are not paired (see FIGS. 4 and 5). If the front cover 220 is rotated toward the rear surface of the body 110 and gets close to the rear cover 210 within a predetermined distance, the first and second antennas 251 and 252 face each other on the same line and are paired with each other (see FIGS. 6 and 7). If a function of outputting specific data of the body 110 to the electronic paper is executed in a menu provided in the body 110, the controller 170 pairs the first and second antennas 251 and 252 by controlling the first and second antennas 251 and 252 and data of the body 110 is transmitted to the second antenna 252 through the first antenna 251 in a non-contact manner. As described before, depending on a setting of the controller 170, a screen displayed on the I/O unit 120 may be output to the auxiliary output unit 240, or an application that enables selection of data to be transmitted to the auxiliary output unit 240 may be executed and user-intended data output from the executed application may be displayed on the auxiliary output unit 240. Accordingly, the second antenna 252 outputs the data received from the first antenna 251 to the electronic paper connected to the second antenna 252. For example, along with pairing between the first and second antennas 251 and 252, a menu may be executed and a specific photo or memo may be output to the electronic paper. In addition, any data may be output to the electronic paper based on user-defined settings.

If the front cover 220 is folded over the front surface of the body 110 in the state where data of the body 110 is output on the electronic paper along with pairing between the first and second antennas 251 and 252, the first and second antennas 251 and 252 are released from the paired state and power is instantaneously blocked to the electronic paper. Nonetheless, the data output to the electronic paper is kept as it is. Accordingly, with the front cover 220 folded to the front surface of the body 110, the data received at the electronic paper is kept displayed on the front surface of the front cover 220.

Therefore, for example, if a photo is output to the electronic paper as described in the above example, the photo is kept displayed on the front cover 220, allowing the user to view the photo on the front cover 220. As another example, if a memo is output to the electronic paper, the memo is kept displayed on the front cover 220. Accordingly, the user may read the memo on the front surface of the device 10. In this manner, the user may readily view a memo otherwise likely to be forgotten. As a final example, if the user sets a schedule to be output to the electronic paper, the schedule is kept displayed on the front cover 220 so that the user may view the schedule.

In addition, the I/O unit 120 and the electronic paper may be utilized in many ways. For example, in the case of an application such as an English vocabulary application, the user may read vocabulary related questions on the I/O unit 120 of the body 110, output answers to such questions to the electronic paper, and then check the answers to the questions by rotating the device 10 to view the front cover 220.

FIG. 9 is a sectional view of a cover unit illustrated in FIGS. 1A and 1B, in which a cover unit covers a portable terminal having a rear case in a body, where the front cover of the cover unit is rotated outward, according to another embodiment of the present invention. In this second embodiment of the present invention, a rear cover 210 of the cover unit 200 is not integrally formed with the body 110, and a rear case 130 is provided on the rear surface of the body 110 and the cover unit 200 covers the body 110 including the rear case 130. FIG. 10 is a sectional view of the device illustrated in FIG. 9, taken along line B-B′ in FIGS. 1A and 1B.

As compared to the foregoing embodiment, shown in FIGS. 5 and 6, in which the rear cover 210 of the cover unit 200 is integrated with the body 110 and the first antenna 251 is provided on the front cover 210, in the second embodiment of the present invention, the rear case 130 is provided to cover the rear surface of the body 110, and the rear cover 210 of the cover unit 200 covers the rear surface of the body 110 including the rear case. Therefore, the first antenna 251 is provided on the rear case 130. The same components or operation as in the forgoing embodiment of the present invention will not be described again to avoid redundancy.

Referring to FIGS. 9 and 10, as described before, the I/O unit 120 is provided on the front surface of the body 110 and the rear case 130 is provided on the rear surface of the body 110, covering a rear bracket in which a battery is mounted. The first antenna 251 of the antenna unit 250 is mounted in an inner surface of the rear case 130 so as to be connected to the body 110. In the flip-type cover unit 200 covering the body 110, the electronic paper and the second antenna 252 of the antenna unit 250 are provided on the front cover 220, whereas the rear cover 210 is formed to a hard material to cover the rear case 130. Therefore, the antenna unit 250 includes the first antenna 251 in the rear case 130 and the second antenna 252 in the front cover 220 in this embodiment of the present invention.

With the front cover 220 folded over the front surface of the body 110, the first antenna 251 mounted in the rear case 130 is not paired with the second antenna 252 mounted in the front cover 220 (see FIGS. 4 and 5). In this state, if the front cover 220 is rotated toward the rear surface of the body 110 and thus approaches the rear cover 210 within a predetermined distance, the first and second antennas 251 and 252 face each other on the same line and are paired with each other. If a function of outputting specific data of the body 110 to the electronic paper is executed in a menu set in the body 110, the controller 170 controls pairing between the first and second antennas 251 and 252 and the data of the body 110 is transmitted to the second antenna 252 through the first antenna 251 in a non-contact manner. The data received at the second antenna 252 is output to the electronic paper connected to the second antenna 252 (see FIG. 8). As described before, upon pairing in the antenna unit 250, items such as photos, memos, and schedules may be output to the electronic paper by executing a specific menu. Data output to the electronic paper may be changed according to settings.

With the data of the body 110 output to the electronic paper upon pairing between the first and second antennas 251 and 252, if the front cover 220 is folded over the front surface of the body 110, the first and second antennas 251 and 252 are released from the paired state and instantaneously power is blocked to the electronic paper. Nonetheless, the data output to the electronic paper is kept as it is. Thus with the front cover 220 folded to the front surface of the body 110, the data received at the electronic paper is kept displayed on the front surface of the front cover 220.

In this manner, the user can readily view a photo, memo, schedule, etc. on the front cover 220 of the cover unit 200 as described before.

As is apparent from the cover device and the portable terminal having the cover device according to the present invention, even though the touch screen is covered, preset content can be output through the cover unit. Thus without opening the cover unit, a user can view the content on the front surface of the cover unit, which increases user convenience with regard to the portable terminal.

Data output on the electronic paper can be maintained without the need for using an additional power supply to keep content output through the cover unit.

Since content output to the front surface of the cover unit can be changed freely, the cover device may have various designs according to a screen displayed on the front surface of the cover unit.

Furthermore, a photo, memo, schedule or the like can be displayed on the electronic paper on the front surface of the front cover according to a user setting. Thus, the user can readily view important information.

While the present invention has been described in the specific embodiments, many modifications can be made without departing from the scope of the present invention. For example, while it has been described by way of example that the antenna unit 250 is configured to include an NFC antenna and an RFID antenna paired with the NFC antenna, any configuration is available to the for the pairing of antennas in the antenna unit 250.

While the first antenna 251 is provided in the rear case 130 in the second embodiment of the present invention, it may be further contemplated that an antenna module of the body 110 is provided in the rear case 130 and the first antenna 251 is provided in the rear cover 210 of the cover unit 200. Thus, the first antenna 251 may be disposed at any position if the position enables pairing between the first and second antennas 251 and 252.

Although embodiments of the invention have been described in detail hereinabove, a person of ordinary skill in the art will understand and appreciate that many variations and modifications of the basic inventive concept described herein will still fall within the spirit and scope of the invention as defined in the following claims and their equivalents.

What is claimed is:

1. A cover device comprising:
a rear cover provided with a first antenna; and
a front cover rotatably connected to the rear cover and provided with a second antenna communicating with the first antenna, in face to face relation, and an output unit outputting data through communication between the first and second antennas.

2. The cover device of claim 1, wherein the output unit includes electronic paper.

3. The cover device of claim 2, wherein when the front cover is rotated towards the rear cover and folded over the rear cover, the first antenna transmits data to the second antenna and the data is output on the electronic paper.

4. The cover device of claim 1, wherein the first antenna includes a Near Field Communication (NFC) antenna and the second antenna includes a Radio Frequency Identification (RFID) antenna paired with the NFC antenna.

5. The cover device of claim 1, wherein the rear cover is a rear case of a portable terminal to which the cover device is attached, and is integrated with the portable terminal.

6. A portable terminal having a cover device, comprising:
a body;
a cover unit detachably installed to the body and including an auxiliary output unit; and
an antenna unit configured to output content of the body to the auxiliary output unit by pairing the body with the cover unit.

7. The portable terminal of claim 6, wherein the cover unit comprises:
a rear cover; and
a front cover rotatably connected to the rear cover and including a front cover provided with the auxiliary output unit.

8. The portable terminal of claim 7, wherein the antenna unit comprises:
a first antenna provided on a rear surface of the body or the rear cover; and
a second antenna provided near to the front cover, to be paired with the first antenna.

9. The portable terminal of claim 8, wherein if the first antenna is provided on the rear cover of the cover unit, and the rear cover is a rear case mounted on the rear surface of the body and is integrated with the body.

10. The portable terminal of claim 6, wherein if the first antenna is provided in the body, the cover unit is configured separately from the body.

11. The portable terminal of claim 8, wherein the first antenna includes a Near Field Communication (NFC) antenna and the second antenna includes a Radio Frequency Identification (RFID) antenna paired with the NFC antenna.

12. The portable terminal of claim 8, wherein the auxiliary output unit includes electronic paper.

13. The portable terminal of claim 12, wherein if the front cover is rotated to the rear cover and folded over the rear cover, the first antenna is adjacent to the second antenna and paired with the second antenna, and data received at the second antenna through the first antenna is output on the auxiliary output unit.

14. The portable terminal of claim 8, wherein an operation mode to transmit data to the auxiliary output unit upon pairing of the first and second antennas is set in the body.

15. The portable terminal of claim 14, wherein if the front cover is rotated towards the rear cover and pairing occurs in the antenna unit, a controller controls transmission of data to the auxiliary output unit according to execution of the operation mode.
